(19) United States
(12) Patent Application Publication
(10) Pub. No.: US 2009/0110818 A1
(43) Pub. Date: Apr. 30, 2009

(54) Shingle With Alternate Granules Under Prime Granules

(76) Inventors: Yihsien H. Teng, Westerville, OH (US); David P. Aschenbeck, Newark, OH (US)

Correspondence Address: OWENS CORNING, 2790 COLUMBUS ROAD, GRANVILLE, OH, 43023, US

(21) Appl. No.: 11/933,262

(22) Filed: Oct. 31, 2007

(51) Int. Cl. B05D 1/12

(52) U.S. Cl. 427/187; 118/40

(57) ABSTRACT

A method of manufacturing roofing shingles including the steps of coating a continuously supplied shingle mat with roofing asphalt to make an asphalt-coated sheet, the asphalt-coated sheet having at least one prime region, applying alternate granules onto the at least one prime region, applying prime granules over the alternate granules to form a granule-covered sheet, and cutting the granule-covered sheet into shingles.

### TECHNICAL FIELD

This invention relates to roofing shingles. More particularly, this invention relates to roofing shingles manufactured with more efficient use of raw materials.

### BACKGROUND OF THE INVENTION

A common method for the manufacture of asphalt shingles is the production of a continuous strip of asphalt shingle material followed by a shingle cutting operation which cuts the material into individual shingles.

In the production of the continuous strip of asphalt shingle material, a substrate such as an organic felt or a glass fiber mat is passed into contact with a coater containing liquid asphalt to form a tacky asphalt coated strip. Subsequently, the hot asphalt coated strip is passed beneath one or more granule applicators which apply the protective surface granules to portions of the asphalt coated strip to form a granule coated sheet. The granule coated sheet is cooled and subsequently cut into individual shingles.

In the manufacturing process, the asphalt coated strip is conceptually divided into an equal number of prime lanes, and headlap lanes. The prime lanes receive an application of prime granules while the headlap lanes receive an application of headlap granules. Headlap granules are normally covered by subsequently laid shingles, whereas prime granules remain exposed. Prime granules are more resistant to attack by long term exposure to sunlight, and consequently prime granules are more expensive than headlap granules. It would be advantageous if shingles could be manufactured with more efficient use of raw materials.

### SUMMARY OF THE INVENTION

According to this invention there is provided a method of manufacturing roofing shingles. The method comprises the steps of coating a continuously supplied shingle mat with roofing asphalt to make an asphalt-coated sheet, the asphalt-coated sheet having at least one prime region, applying alternate granules onto the at least one prime region, applying prime granules over the alternate granules to form a granule-covered sheet, and cutting the granule-covered sheet into shingles.

According to this invention there is also provided an apparatus for manufacturing roofing shingles, the roofing shingles having at least one prime region. The apparatus comprises an asphalt coater configured to receive a shingle mat traveling in a machine direction. The asphalt coater is configured to coat the shingle mat with asphalt. The apparatus further includes a source of alternate granules and at least one alternate granule applicator positioned downstream from the asphalt coater. The at least one granule applicator is configured to apply alternate granules onto the at least one prime region. The apparatus also includes a source of prime granules and at least one prime granule applicator positioned downstream from the at least one alternate granule applicator. The at least one prime granule applicator is configured to apply prime granules over the alternate granules to form a granule-covered sheet. A drum is positioned downstream from the at least one prime granule applicator. The drum is configured to press the prime granules into the sheet and remove the granules which are not adhered to the granule-covered sheet. A cutter is positioned downstream from the drum. The cutter is configured to cut the granule-covered sheet into shingles.

Various advantages of this invention will become apparent to those skilled in the art from the following detailed description of the invention, when read in light of the accompanying drawings.

### BRIEF DESCRIPTION OF THE DRAWINGS

FIG. 1 is a schematic elevational view, partially in cross section, of a portion of an apparatus for making shingles according to the method of the invention.

FIG. 2 is a schematic plan view of a portion of an asphalt-coated sheet, showing a roofing shingle, made according to the method of this invention.

FIG. 3 is an enlarged schematic cross-sectional elevational view of the prime lane of the roofing shingle illustrated in FIG. 2.

### DETAILED DESCRIPTION OF THE INVENTION

Composite shingles, such as asphalt shingles, are a commonly used roofing product. Asphalt shingle production generally includes feeding a base material from an upstream roll and coating it first with a roofing asphalt material, then a layer of granules. The base material is typically made from a fiberglass mat provided in a continuous shingle membrane or sheet. It should be understood that the base material can be any suitable support material.

Composite shingles may have a headlap region and a prime region. The headlap region may be ultimately covered by adjacent shingles when installed upon a roof. The prime region will be ultimately visible when the shingles are installed upon a roof.

The granules deposited on the composite material shield the roofing asphalt material from direct sunlight, offer resistance to fire, and provide texture and color to the shingle. The granules generally involve at least two different types of granules. Headlap granules are applied to the headlap region. Headlap granules are relatively low in cost and primarily serve the functional purposes of covering the underlying asphalt material for a consistent shingle construction, balancing sheet weight and preventing overlapping shingles from sticking to one another. Colored granules or other prime granules are relatively expensive and are applied to the shingle at the prime regions. Prime granules are disposed upon the asphalt strip for both the functional purpose of protecting the underlying asphalt strip and for the purpose of providing an aesthetically pleasing appearance of the roof.

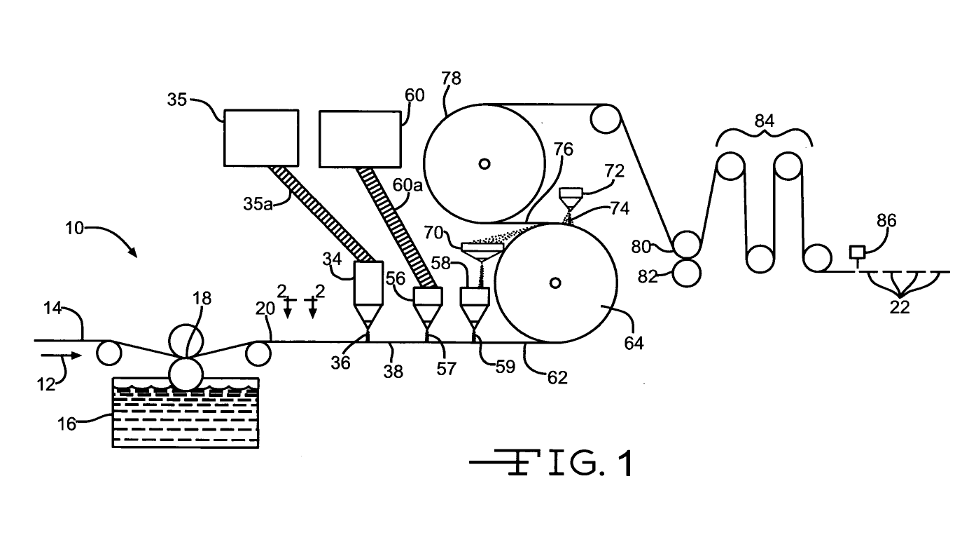

The description and drawings disclose a method and apparatus for manufacturing an asphalt shingle having a predetermined percentage of alternate granules disposed beneath the prime granules on the prime region of the shingle. Referring now to the drawings, there is shown in FIG. 1 an apparatus 10 for manufacturing asphalt-based shingles according to the invention. The illustrated manufacturing process involves passing a continuous sheet in a machine direction (indicated by an arrow 12) through a series of manufacturing operations. The sheet usually moves at a speed from about 300 feet/minute to about 800 feet/minute. However, other speeds can be used.

In a first step of the manufacturing process, a continuous sheet of shingle mat 14 is payed out from a roll (not shown). The shingle mat 14 can be any type of substrate suitable for use in reinforcing asphalt-based roofing shingles, such as a nonwoven web of glass fibers. The shingle mat 14 is fed, in machine direction 12, through a coater 16 where a coating of asphalt 18 is applied to the shingle mat 14. The asphalt coating 18 can be applied in any suitable manner. In the illustrated embodiment, the shingle mat 14 contacts a supply of hot, melted asphalt 18 to completely cover the shingle mat 14 with a tacky coating of asphalt 18. However, in other embodiments, the asphalt coating 18 could be sprayed on, rolled on, or applied to the shingle mat 14 by other means. Typically the asphalt coating is highly filled with a ground mineral filler material, amounting to at least about 60 percent by weight of the asphalt/filler combination. In one embodiment, the asphalt coating 18 is in a range from about 350° F. to about 400° F. In another embodiment, the asphalt coating 18 can be more than 400° F. or less than 350° F. The shingle mat 14 exits the coater 16 as an asphalt-coated sheet 20. The asphalt coating 18 on the asphalt-coated sheet 20 remains hot.

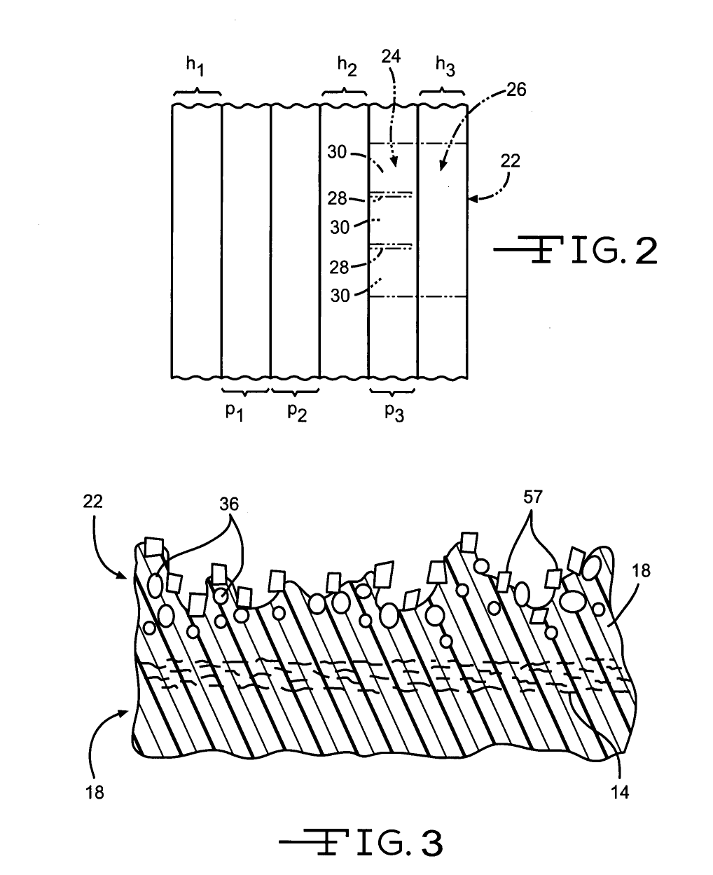

The asphalt-coated sheet 20 is shown in more detail in FIG. 2. As shown, the asphalt-coated sheet 20 for the three-wide apparatus 10 comprises six distinct regions or lanes including three headlap lanes h1, h2, and h3, and three prime lanes p1, p2, and p3. An exemplary roofing shingle is shown by a phantom line 22 and may be cut from asphalt-coated sheet 20 as shown. In this manner, three roofing shingles of any length desired may be cut from each such section of asphalt-coated sheet 20. Each shingle 22 would contain one headlap lane h1, h2, or h3, and one respective adjacent prime lane p1, p2, or p3. Accordingly, the shingle 22 includes a headlap region 26 and a prime region 24.

The headlap region 24 of the shingle 22 is that portion which is covered by adjacent shingles when the shingle 22 is ultimately installed upon a roof. The prime region 26 of the shingle 22 is that portion which remains exposed when the shingle 22 is ultimately installed upon a roof.

In this embodiment, the shingle 22 is cut from the asphalt-coated sheet 20 to be three feet long by one foot wide. As further shown in FIG. 2, the shingle 22 includes two cut-out regions 28 which define three tabs 30. It will be apparent to one skilled in the art that the asphalt-coated sheet 20 may be manufactured having a wide variety of widths to allow different numbers of shingles to be cut therefrom. For example, some roofing shingle manufacturing plants use an asphalt-coated sheet (not shown) which is sufficiently wide to allow four, one foot wide shingles to be cut therefrom. Such a wider asphalt-coated sheet would include an additional headlap region, and an additional prime region. One skilled in the art will also recognize that roofing shingles of different sizes, i.e. roofing shingles having different lengths and/or widths, may be cut from the asphalt-coated sheet 20.

Referring again to FIG. 1, the asphalt-coated sheet 20 is passed beneath an alternate granule applicator 34. The alternate granule applicator 34 is configured to apply alternate granules 36 onto the prime lanes p1, p2, and p3 at a predetermined, adjustable feed rate. The alternate granule applicator 34 can be of any type of applicator, blender or dispenser, having an adjustable feed rate and being suitable for applying alternate granules 36 onto the asphalt-coated sheet 20, such as for example a fluted roll applicator, gravity feed applicator or an auger-type dispenser. Although one alternate granule applicator 34 is shown in the embodiment illustrated in FIG. 1, any suitable number and configuration of alternate granule applicators 34 can be used. The alternate granule applicator 34 is fed from an alternate granule hopper 35 via an alternate granule hose 35a. The alternate granule hopper 35 can be any hopper suitable for supplying alternate granules 36 to the alternate granule applicator 34.

The phrase “alternate granules” as used herein, is defined to include any granules having a cost less than the cost of the prime granules. In one embodiment, the cost of the alternate granules 36 can be in a range from about 20 percent to about 70 percent of the cost of the prime granules. Alternatively, the alternate granules 36 can be less than 20 percent or more than 70 percent of the cost of the prime granules. As previously mentioned, the alternate granules 36 shield the roofing asphalt material from direct UV rays from sunlight, offer resistance to fire, and provide texture and color to the shingle. After application to the asphalt-coated sheet 20, the alternate granules 36 are substantially enveloped by the asphalt coating 18, requiring the alternate granules 36 to be resistant to temperatures in a range from about 350° F. to about 400° F. Alternatively, the alternate granules 36 can be heat resistant to temperatures in excess of about 400° F. The alternate granules 36 can include granules from many sources. Examples of sources of alternate granules 36 include recycled prime granules, granules applied to non-weather exposed areas of the shingle (headlap granules), relatively inexpensive natural rock granules, granules produced from scrap ceramics, granules from scrap and excess building materials and slag materials from metal refining and coal burning. The alternate granules 36 can also be prime granules of such low grade so as to unsuitable for use as prime granules. Examples of low grade prime granules include prime granules having defective coloring, an inconsistent or thinner than desired ceramic coating, inconsistent granule sizing or a larger or smaller than desired size. In one embodiment as shown in FIG. 3, the alternate granules 36 are approximately the same size as the prime granules 57. In another embodiment, the alternate granules 36 can be larger or smaller than the prime granules 57.

Applying alternate granules 36 to the prime lanes p1, p2, and p3 of the asphalt-coated sheet 20 defines a partial alternate granule coated sheet 38. As further illustrated in FIG. 1, the partial alternate granule coated sheet 38 is passed beneath a series of granule applicators 56 and 58 for applying prime and headlap granules onto the partial alternate granule coated sheet 38. The granule applicators 56 and 58 can be of any type suitable for applying onto the partial alternate granule coated sheet 38. An example of a granule applicator, 56 and 58, is a granule applicator of the type disclosed in U.S. Pat. No. 5,599,581 to Burton et al., which is hereby incorporated by reference, in its entirety. Additionally, a granule valve such as the granule valve disclosed in U.S. Pat. No. 6,610,147 to Aschenbeck may also be used. U.S. Pat. No. 6,610,147 to Aschenbeck is also incorporated by reference in its entirety. The prime granule applicator 56 is fed from a prime granule hopper 60 via a prime granule hose 60a. The prime granule hopper 60 can be any hopper suitable for supplying prime granules 57 to the prime granule applicator 56.

Although two granule applicators 56 and 58 are shown in the embodiment illustrated in FIG. 1, any suitable number and configuration of granule applicators can be used. For example, a series of two prime granule applicators can be used, wherein the granule applicator 56 can be used to apply prime granules 57 onto the prime lanes p1, p2 and p3. Similarly, the granule applicator 58 can be used to apply headlap granules 59 on the headlap lanes h1, h2 and h3. Applying prime granules 57 and headlap granules to the partial alternate granule coated sheet 38 defines a granule-covered sheet 62. In another embodiment, additional granule applicators can be used for additional granule drops, such as different colors, sharp demarcations and background granules.

In the embodiment shown in FIG. 1, subsequent to the application of the alternate granules 36 onto the prime lanes p1, p2 and p3 by the granule applicator 34, the application of the prime granules 57 by the granule applicator 56 onto the prime lanes p1, p2 and p3, substantially forces, by the weight of the prime granules 57, the alternate granules 36 into the asphalt coating 18. As shown in FIG. 3, substantially all of the alternate granules 36 are completely enveloped within the asphalt coating 18. It will be understood that the phrase “substantially all” is defined as within the range of from about 60 percent to about 90 percent of the alternate granules 36. The range of the alternate granules 36 enveloped within the asphalt coating 18 can be verified by microscopic examination of a cross-sectional portion of the prime region 24 of the shingle 22. As will be explained later in more detail, subsequent shingle manufacturing operations also press the alternate granules 36 and the prime granules into the asphalt coating 18.

As further shown in FIG. 3, while substantially all of the alternate granules 36 are enveloped by the asphalt coating 18, some of the alternate granules 36 will be visible on the prime region 24 of the shingle 22. In order to maintain the desired appearance of the prime region 24 of the shingle 22, the color of the alternate granules 36 can optionally be coordinated with the ingredient color of the prime granules 57. In one embodiment, the alternate granules 36 are in the same color family as the ingredient color of the prime granules 57. The phrase “color family” is defined as having a total color difference ΔE* between the alternate granules 36 and the prime granules 57 within +/−5, where ΔE*=((ΔL*)²+(Δa*)²+(Δb*)²)^{1/2} based on the CIE L*, a* b* color scale. In another embodiment, the alternate granules 36 can have a total color difference ΔE* more than or less than +/−5. Alternatively, another desired appearance of the prime region 24 can be achieved by using alternate granules 36 in a different or contrasting color family. In another embodiment where the alternate granules 36 contain multiple colored ingredients, there is at least one ingredient color in the alternate granules 36 having a total color difference ΔE* with the ingredient color of the prime granules 57 within +/−5 based on the CIE L*, a* b* color scale.

Referring again to FIG. 1, the output of the alternate granule applicator 34 is controlled such that the alternate granules 36 constitute a predetermined percentage of the total volume of all granules which ultimately envelop within the prime lanes p1, p2, and p3 of the asphalt-coated sheet 20. In one embodiment, the predetermined percentage of alternate granules 36 is within a range from about 5 percent to about 20 percent of the total volume of all granules which ultimately adhere to the prime lanes p1, p2, and p3 of the asphalt-coated sheet 20. For example, if a total of thirty pounds (30 lbs.) of granules adhere to each 100 square feet of a prime lane p1, p2 and p3, approximately 10 percent or three pounds (3 lbs), of these granules would be alternate granules 36. It will be appreciated however, that the amount of alternate granules 36 may vary. In one embodiment, the amount of alternate granules 36 can vary depending on the color difference between the alternate granules 36 and the prime granules 57. In this embodiment, if both the color of the alternate granules 36 and the prime granules 57 substantially match each other in overall color, a much higher percentage of alternate granules 36 can be applied.

In one embodiment as shown in FIG. 1, the application of the headlap granules 59 to the headlap lanes h1, h2 and h3 of the asphalt-coated sheet 20 occurs after the application of the alternate granules 36 and the prime granules 57 to the prime lanes p1, p2 and p3. Alternatively, the application of the headlap granules 59 to the headlap lanes h1, h2 and h3 may occur before or at the same time as the application of the alternate granules 36 and the prime granules 57 to the prime lanes p1, p2 and p3.

As shown in FIG. 1, after all the granules are deposited on the asphalt-coated sheet 20, the granule-covered sheet 62 is turned around a slate drum 64 to press the alternate granules 36, prime granules 57 and headlap granules 59 into the asphalt coating 18. The slate drum 64 temporarily inverts the granule-covered sheet 62 so that the excess and non-adhering granules fall off. The excess granules fall into a backfall hopper 70. The backfall hopper 70 is configured to accumulate the recovered granules for later use as alternate granules 36.

In one embodiment as shown in FIG. 1, while the granule-covered sheet 62 is inverted, a backdust applicator 72 is positioned to apply a thin layer of backdust material 74 to a bottom surface 76 of the granule-covered sheet 62. The backdust material 74 is configured to adhere to the bottom surface 76 of the granule-covered sheet 62 and results in a substantially less tacky bottom surface 76 for downstream shingle production operations. In one embodiment, the backdust material 74 is sand. Alternatively, the backdust material 74 can be any material, such as for example natural rock dust or small glass particles, sufficient to adhere to the bottom surface 76 of the granule-covered sheet 62 and result in a substantially less tacky bottom surface 76.

Subsequent to the application of the backdust material 74, the granule-covered sheet 62 is turned around a sand drum 78 to press the backdust material 74 into the bottom surface 76 of the granule-covered sheet 62.

The granule-covered sheet 62 is passed between a pair of press rolls 80, 82 that further press the alternate granules 36, prime granules 57 and headlap granules 59 into the granule-covered sheet 62.

As further shown in FIG. 1, downstream from the press rolls, 80 and 82, the granule covered-sheet 62 is passed through a cooling section 84. The cooling section 84 is configured to sufficiently cool the granule-covered sheet 62 to allow downstream manufacturing operations. In one embodiment, the cooling section 84 includes rollers allowing the granule-covered sheet 62 to be passed up and down while being sprayed with water to cool the hot asphalt coating 18. In another embodiment, any means of cooling the granule-covered sheet 62 can be used.

Downstream from the cooling section 84, the granule-covered sheet 62 is subsequently fed through a cutter 86 that cuts the granule-covered sheet 62 into individual shingles 22. The cutter 86 may be any type of cutter, such as for example a rotary cutter, sufficient to cut the granule-covered sheet 62 into individual shingles 22.

The principle and mode of operation of this invention have been described in its preferred embodiments. However, it should be noted that this invention may be practiced otherwise than as specifically illustrated and described without departing from its scope.

What is claimed is:

1. A method of manufacturing roofing shingles comprising the steps of:
coating a continuously supplied shingle mat with roofing asphalt to make an asphalt-coated sheet, the asphalt-coated sheet having at least one prime region;
applying alternate granules onto the at least one prime region;
applying prime granules over the alternate granules to form a granule-covered sheet; and
cutting the granule-covered sheet into shingles.

2. The method of claim 1 in which the alternate granules are made from one or more of the group consisting of recovered prime granules, low grade prime granules, headlap granules and natural rock granules.

3. The method of claim 1 in which the prime granules have at least one ingredient color in a color family and the alternate granules have at least one ingredient color, wherein the total color difference ΔE* between the at least one ingredient color of the prime granules and the at least one ingredient color of the alternate granules is within +/−5 based on the CIE L*, a* b* color scale.

4. The method of claim 1 in which substantially all of the alternate granules are completely enveloped within the asphalt-coated sheet under the prime granules.

5. The method of claim 1 in which the alternate granules constitute a predetermined percentage of the total volume of all granules which ultimately adhere to the prime region of the asphalt-coated sheet.

6. The method of claim 5 in which the predetermined percentage of alternate granules is within the range from about 5.0 percent to about 20.0 percent.

7. An apparatus for manufacturing roofing shingles, the roofing shingles having at least one prime region, the apparatus comprising:
an asphalt coater configured to receive a shingle mat traveling in a machine direction, the asphalt coater configured to coat the shingle mat with asphalt;
a source of alternate granules;
at least one alternate granule applicator positioned downstream from the asphalt coater, the at least one alternate granule applicator configured to apply alternate granules onto the at least one prime region;
a source of prime granules;
at least one prime granule applicator positioned downstream from the at least one alternate granule applicator, the at least one prime granule applicator configured to apply prime granules over the alternate granules to form a granule-covered sheet;
a drum positioned downstream from the at least one prime granule applicator, the drum configured to press the prime granules into the sheet and remove the granules which are not adhered to form a granule-covered sheet; and
a cutter positioned downstream from the drum, the cutter being configured to cut the granule-covered sheet into shingles.

8. The apparatus of claim 7 in which the at least one alternate granule applicator is configured to apply alternate granules onto the at least one prime region at a first output rate and the at least one prime granule applicator is configured to apply prime granules over the alternate granules at a second output rate.

9. The apparatus of claim 8 in which the first output rate is slower than the second output rate.

10. The apparatus of claim 7 in which the at least one alternate granule applicator is a different type of applicator than the at least one prime granule applicator.

11. The apparatus of claim 7 in which the at least one alternate granule applicator is a fluted roll type of applicator.
